(19) United States
(12) Patent Application Publication
(10) Pub. No.: US 2008/0160300 A1
(43) Pub. Date: Jul. 3, 2008

(54) Composition for pressure sensitive adhesive film, pressure sensitive adhesive film, and dicing die bonding film including the same

(76) Inventors: Yong Ha Hwang, Bucheon-si (KR); Gyu Seok Song, Uiwang-si (KR); Hee Yeon Ki, Yongin-si (KR); Kyoung Jin Ha, Seoul (KR); Jae Hyun Cho, Seoul (KR); Jun Suk Kim, Seoul (KR); Chang Beom Chung, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 12/005,403

(22) Filed: Dec. 27, 2007

(30) Foreign Application Priority Data
Dec. 27, 2006 (KR) 10-2006-0134916
Dec. 28, 2006 (KR) 10-2006-0136203

(51) Int. Cl. B32B 7/12; C08J 3/28

(52) U.S. Cl. 428/345; 522/12; 522/8; 522/20

(57) ABSTRACT

A composition, including a polymer binder resin A, a UV-curing acrylate B, a heat curing agent C, and a photopolymerization initiator D. The composition includes about 20 to about 150 parts by weight of the UV-curing acrylate B per 100 parts by weight of the polymer binder resin A, and the UV-curing acrylate B is a solid or near-solid at room temperature and has a viscosity of about 10,000 cps or more at 40° C.

### BACKGROUND OF THE INVENTION

1. Field of the Invention

Embodiments relate to a composition for pressure sensitive adhesive film, a pressure sensitive adhesive film, and a dicing die bonding film including the same.

2. Description of the Related Art

In semiconductor manufacturing processes, a large-diameter wafer on which circuits are constructed may be cleaved into small chips, or dies, in a dicing operation. A dicing film may be attached to the wafer for the dicing operation. A pick-up operation may then be performed and the separated chips may then be adhered for packaging. Each of the individual chips may be adhered to a support member such as another active device, a printed circuit board (PCB), a lead frame, etc., through adhesive bonding. This method involves two steps (dicing and adhesion), and thus may be disadvantageous in terms of cost and productivity.

Another method known as “chip adhesion on back side of wafer” may employ a single film that incorporates a dicing tape and a pressure sensitive adhesive (PSA). Such films include a first type of film in which separate PSA and adhesive layers are provided, the PSA for dicing and the adhesive for adhesion of the chip to the support member, and a second type of film in which a single layer is provided for both dicing and adhesion. In the first type of film, the PSA film may be a light-curing film, e.g., a UV-curing film, which exhibits a strong initial adhesion so as to strongly hold a chip during dicing drying, etc., and which exhibits a reduced adhesion following UV irradiation, to help ensure transfer during the pick-up operation. Generally, however, when commonly known PSA compositions are employed, a UV-curing type low-molecular-weight material in the PSA may migrate to the neighboring adhesive layer, which may complicate the pick-up process.

### SUMMARY OF THE INVENTION

Embodiments are therefore directed to a composition for a pressure sensitive adhesive film, a pressure sensitive adhesive film, and a dicing die bonding film including the same, which substantially overcome one or more of the problems due to the limitations and disadvantages of the related art.

It is therefore a feature of an embodiment to provide a dicing die bonding film.

It is therefore another feature of an embodiment to provide a pressure sensitive adhesive film that exhibits a sea-island structure.

It is therefore another feature of an embodiment to provide a composition for a pressure sensitive adhesive film.

At least one of the above and other features and advantages may be realized by providing a composition including a polymer binder resin A, a UV-curing acrylate B, a heat curing agent C, and a photopolymerization initiator D. The composition may include about 20 to about 150 parts by weight of the UV-curing acrylate B per 100 parts by weight of the polymer binder resin A, and the UV-curing acrylate B may be a solid or near-solid at room temperature and may have a viscosity of about 10,000 cps or more at 40° C. The composition may include about 0.1 to about 10 parts by weight of the heat curing agent C per 100 parts by weight of the polymer binder resin A, and the composition may include about 0.1 to about 5 parts by weight of the photopolymerization initiator D per 100 parts by weight of the UV-curing acrylate B. The heat curing agent C may include one or more of a polyisocyanate, a melamine/formaldehyde resin, or an epoxy resin. The photopolymerization initiator D may include one or more of a benzophenone compound, an acetophenone compound, or an anthraquinone compound. The polymer binder resin A may be an acryl resin having one or more of a hydroxy functional group, a carboxyl functional group, an epoxy functional group, or an amine functional group. The acryl resin may have a glass transition temperature of about −60° C. to about 0° C. and a weight-average molecular weight of about 100,000 to about 2,000,000. The UV-curing acrylate B may be a urethane acrylate oligomer.

At least one of the above and other features and advantages may also be realized by providing a composition, including a polymer binder resin A, a UV-curing urethane acrylate oligomer B1, a UV-curing acrylate B2, a heat curing agent C, and a photopolymerization initiator D. The composition may include about 20 parts to about 150 parts by weight of the UV-curing urethane acrylate oligomer B1, per 100 parts by weight of the polymer binder resin A, the composition may include about 5 parts to about 50 parts by weight of the UV-curing acrylate B2, per 100 parts by weight of the polymer binder resin A, the UV-curing urethane acrylate oligomer B1 may be a solid or near-solid at room temperature and may have a viscosity of about 10,000 cps or more at 40° C., and the UV-curing acrylate B2 may be a solid or wax and may have a melting point above about 25° C. The UV-curing urethane acrylate oligomer B1 may include a copolymer of a terminal isocyanate urethane prepolymer and a hydroxy acrylate. The UV-curing acrylate B2 may include one or more of trimethylolpropane tri(meth)acrylate, pentaerythritol tetraacrylate, tris(2-acryloxyethyl)isocyanulate, methoxy polyethyleneglycol 1000 methacrylate, methoxy polyethyleneglycol 1000 acrylate, behenyl acrylate, polyethyleneglycol 1000 dimethacrylate, polyethyleneglycol 1000 diacrylate, or tetramethylolmethane tetraacrylate. The UV-curing acrylate B2 may include one or more acrylates, each of which may be a solid or wax and may have a melting point above about 25° C. The polymer binder resin A may be an acryl resin having one or more of a hydroxy functional group, a carboxyl functional group, an epoxy functional group, or an amine functional group.

At least one of the above and other features and advantages may also be realized by providing a dicing die bonding film, including a support film, an adhesive layer on the support film, and a pressure sensitive adhesive film on the adhesive layer. The pressure sensitive adhesive film may include a polymer binder resin A, a UV-curing acrylate B, a heat curing agent C, and a photopolymerization initiator D, the pressure sensitive adhesive film may include about 20 to about 150 parts by weight of the UV-curing acrylate B per 100 parts by weight of the polymer binder resin A, and the UV-curing acrylate B may be a solid or near-solid at room temperature and may have a viscosity of about 10,000 cps or more at 40° C. The polymer binder resin A may be an acryl resin having one or more of a hydroxy functional group, a carboxyl functional group, an epoxy functional group, or an amine functional group. The acryl resin may have a glass transition temperature of about −60° C. to about 0° C. and a weight-average molecular weight of about 100,000 to about 2,000,000. The UV-curing acrylate B may be a urethane acrylate oligomer. The adhesive layer may include an acryl resin. The pressure sensitive adhesive film may have a sea-island structure in which the islands have an average size of about 1 μm to about 10 μm.

At least one of the above and other features and advantages may also be realized by providing a dicing die bonding film, including a support film, an adhesive layer on the support film, and a pressure sensitive adhesive film on the adhesive layer. The pressure sensitive adhesive film may include a polymer binder resin A, a UV-curing urethane acrylate oligomer B1, a UV-curing acrylate B2, a heat curing agent C, and a photopolymerization initiator D, the pressure sensitive adhesive film may include about 20 to about 150 parts by weight of the UV-curing urethane acrylate oligomer B1 per 100 parts by weight of the polymer binder resin A, the pressure sensitive adhesive film may include about 5 parts to about 50 parts by weight of the UV-curing acrylate B2, per 100 parts by weight of the polymer binder resin A, the UV-curing urethane acrylate oligomer B1 may be a solid or near-solid at room temperature and may have a viscosity of about 10,000 cps or more at 40° C., and the UV-curing acrylate B2 may be a solid or wax and may have a melting point above about 25° C. The UV-curing urethane acrylate oligomer B1 may include a copolymer of a terminal isocyanate urethane prepolymer and a hydroxy acrylate. The UV-curing acrylate B2 may include one or more of trimethylolpropane tri(meth)acrylate, pentaerythritol tetraacrylate, tris(2-acryloxyethyl)isocyanulate, methoxy polyethyleneglycol 1000 methacrylate, methoxy polyethyleneglycol 1000 acrylate, behenyl acrylate, polyethyleneglycol 1000 dimethacrylate, polyethyleneglycol 1000 diacrylate, or tetramethylolmethane tetraacrylate. The adhesive layer may include an acryl resin. The pressure sensitive adhesive film may have a sea-island structure in which the islands have an average size of about 1 μm to about 10 μm.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a cross-sectional view of a dicing die bonding film according to an embodiment;

FIGS. 2 to 5 illustrate cross-sectional views of stages in a method of a combined process of dicing and die bonding using the dicing die bonding film of FIG. 1;

FIG. 6 illustrates a sea-island surface structure of a pressure sensitive adhesive film according to an embodiment;

FIG. 7 illustrates a table of components and test results for Examples 1-1 and 1-2, and Comparative Examples 1-1 through 1-5; and

FIG. 8 illustrates a table of components and test results for Examples 2-4 through 2-6, and Comparative Examples 2-7 through 2-12.

### DETAILED DESCRIPTION OF THE INVENTION

Korean Patent Application No. 10-2006-0134916, filed on Dec. 27, 2006, and Korean Patent Application No. 10-2006-0136203, filed on Dec. 28, 2006, in the Korean Intellectual Property Office, both entitled: “Photocuring Composition for Forming Adhesive Film and Dicing Die Bonding Film Including the Same,” are incorporated by reference herein in their entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

As used herein, the terms “a” and “an” are open terms that may be used in conjunction with singular items or with plural items. For example, the term “a photopolymerization initiator” may represent a single compound, e.g., benzophenone, or multiple compounds in combination, e.g., benzophenone mixed with acetophenone.

As used herein, molecular weights of polymeric materials are weight average molecular weights, unless otherwise indicated.

As used herein, the language “parts by weight, based on the total amount of the adhesive film composition” is exclusive of solvent, unless otherwise indicated. That is, as used herein, the point of reference “the total amount of the adhesive film composition” does not include solvent. For example, where a composition is composed of two components A and B, with A present in 35 parts by weight and B present in 65 parts by weight, based on the total amount of the adhesive film composition, the addition of 10 parts by weight of solvent to the composition would result in the composition continuing to have 35 parts by weight A and 65 parts by weight B, based on the total amount of the adhesive film composition.

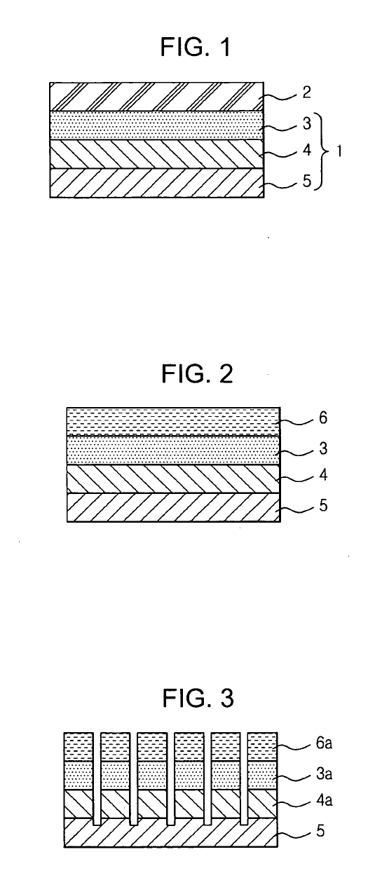

FIG. 1 illustrates a cross-sectional view of a dicing die bonding film 1 according to a first embodiment, in which a PSA and an adhesive are arranged in separate layers, and FIGS. 2 to 5 illustrate cross-sectional views of stages in a method of a combined process of dicing and die bonding using the dicing die bonding film of FIG. 1. Referring to FIG. 1, a PSA film 4 according to a second embodiment may be disposed on one side of an expandable support film 5, which may be, e.g., a polyolefin. An adhesive layer 3 to adhere chips may be disposed on the PSA film 4. A release film 2 may be disposed on the dicing die bonding film 1 to protect the adhesive layer 3. The PSA film 4 in the dicing die bonding film 1 may be formed from a PSA composition according to a third embodiment, details of which are set forth below.

Referring to FIG. 2, in the semiconductor manufacturing process, the adhesive layer 3 may be laminated on a wafer 6 after peeling off the release film 2. After the lamination of the adhesive layer 3 on the wafer 6, chips 6a may be cleaved from the wafer 6 by dicing, with the size of the chip 6a corresponding to the size of the designed circuitry. Referring to FIG. 3, dicing may include separating the dicing die bonding film 1 to a depth of an upper part of the support film 5 below the PSA film 4, such that dicing separates wafer 6 into chips 6a, separates the adhesive layer 3 into adhesive layer parts 3a, and separates the PSA film 4 into PSA film parts 4a.

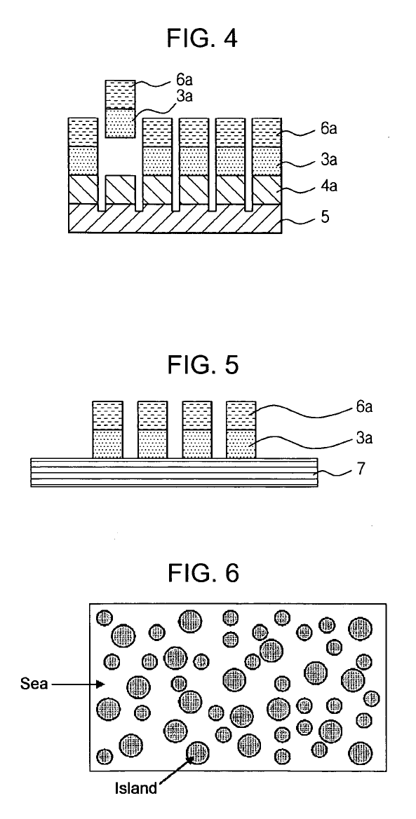

After dicing, the interfacial peel strength between the PSA film parts 4a and the adhesive layer parts 3a may be decreased by irradiating the PSA film parts 4a with UV light. UV-light induced changes in the PSA film parts 4a may result in a reduced peel strength that enables pick-up of individual chips 6a, allowing the chips 6a to be separated from the PSA film parts 4a so that they can be attached to a support member 7. As seen in FIG. 4, individual chips 6a, on which the adhesive layer parts 3a remain adhered, may be picked up, e.g., with a pick-up machine or collet, and attached on a support member 7, which may be, e.g., another active device, a PCB substrate, a lead frame, etc. (see FIG. 5).

### Support Film 5

Various types of plastic film may be employed as the support film 5 of the dicing die bonding film 1. A thermoplastic film may be used as the support film 5. Preferably, the support film 5 is expandable. Where the wafer 6 to be diced is not transparent to UV light, the support film 5 is preferably transparent to UV light in order to allow UV irradiation to impinge upon the PSA layer parts 3a and thereby effect a reduction in peel strength. In this case, the support film 5 may exhibit good transmittance in the UV wavelength range used to cure the PSA film parts 4a.

Examples of polymer films that may be used as support film 5 include, e.g., polyolefin-based films such as polyethylene, polypropylene, ethylene/propylene copolymer, polybutene-1, ethylene/vinyl acetate copolymer, polyethylene/styrene-butadiene rubber mixture, polyvinyl chloride, etc. In addition, plastics such as polyethylene terephthalate, polycarbonate, poly(methyl methacrylate), etc., and thermoplastic elastomers such as polyurethane, polyamide-polyol copolymer, etc., may be used. Such materials may be used alone or in mixtures thereof.

The support film 5 may have a multi-layered structure, which may enable cleavage and/or expansion during dicing. The support film 5 may be formed by, e.g., blending polyolefin chips and performing extrusion, by blowing, etc. The heat resistance and mechanical properties of the support film 5 may depend on the polyolefin chips that are blended.

The support film 5 may have a haze value of about 85 or more. Such a haze value may be attained by, e.g., embossing one side of the polyolefin film using an engraved cooling roll. If the support film 5 has a haze value of about 85 or more, it may be easier to recognize the location of the support film 5 when it is laminated on one side of the wafer 6, before the support film 5 is cut, which may simplify continuous work. Embossing the support film 5 may also help enable rolling of the support film 5 during film fabrication by preventing blocking.

The PSA film 4 may be formed on the side of the support film 5 opposite the side that is embossed. In order to improve adhesion force of the PSA film 4 with respect to the support film 5, it may be preferable to surface treat the un-embossed side of the support film 5. The surface treatment may include physical and/or chemical modification of the surface. Physical methods include, e.g., corona treatment and plasma treatment, and chemical methods include, e.g., in-line coating, primer treatment, etc. Corona discharge treatment may be used to modify the surface to make coating of the PSA film 4 easier.

The support film 5 may have a thickness of about 30 μm to about 300 μm, preferably about 50 μm to about 200 μm. The support film 5 having such a thickness may provide good elongation, ease of working, UV transmittance, etc. Using a support film 5 having a thickness of about 30 μm or more may help avoid difficulties in working the support film 5 in the pre-cut state, and may help prevent the film from being deformed by heat generated during UV irradiation of the PSA film 4. Using a support film 5 having a thickness of about 300 μm or less may reduce costs by enabling a lower force to be employed during the expanding operation.

### PSA Film 4

The PSA film 4 may be prepared by applying the composition according to the third embodiment on one side of the support film 5. The PSA film 4 may be formed on the support film 5 by, e.g., direct coating of the PSA composition on the support film, by coating the PSA composition on a release film and then transferring the resulting PSA film 5 to the support film 5, etc. The coating of the PSA composition may be performed by a suitable coating method such as bar coating, gravure coating, comma coating, reverse roll coating, applicator coating, spray coating, etc.

The PSA film 4 used in the dicing die bonding film 1 may provide strong adhesion to the adhesive layer 3 and to a ring frame. The PSA film 4 may exhibit a strong tack before UV irradiation. After UV irradiation, the PSA film 4 may exhibit a significantly reduced adhesion force at the interface with the adhesive layer 3 due to increased cohesiveness of the PSA film parts 4a, so that the chips 6a and the adhesive layer parts 3a may be easily picked up and die bonded to the support member 7. In another implementation, the PSA film 4 may be a film that exhibits a reduction in adhesion force at the interface with the adhesive layer 3 as a result of other energy input, e.g., heat curing, etc.

The PSA film 4 may be prepared using the composition according to the third embodiment, the composition including a polymer binder resin A, a UV-curing acrylate B, a heat curing agent C and a photopolymerization initiator D. The composition may include about 20 to about 150 parts by weight of the UV-curing acrylate B per 100 parts by weight of a polymer binder resin A, about 0.1 to about 10 parts by weight of the heat curing agent C per 100 parts by weight of a polymer binder resin A, and about 0.1 to about 5 parts by weight of the photopolymerization initiator D per 100 parts by weight of the UV-curing acrylate B. The composition may further include one or more of, e.g., an organic filler, an inorganic filler, an adhesion promoter, a surfactant, an antistatic agent, etc.

The polymer binder resin A may impart pressure sensitive adhesive properties to the PSA film 4. The polymer binder resin A may be mixed with the UV-curing acrylate B to induce crosslinking of the PSA binder with acrylate, in order to provide a significant decrease of adhesion force after UV irradiation. Acryl-based resins may be used for the polymer binder resin A, and may provide good cohesiveness and superior heat resistance, and allow the easy introduction of functional groups and/or low-molecular-weight side chains through chemical reaction. Further, the use of acryl-based resins may allow the glass transition temperature and/or molecular weight to be controlled by selecting appropriate monomers. Similarly, the introduction of functional groups at side chains may be controlled by selecting appropriate monomers. Various other resins, e.g., polyester-based resins, urethane-based resins, silicone-based resins and rubber-based resins, may also be used for the polymer binder resin A.

In the acryl-based resin, the monomers used for copolymerization may include, e.g., butyl acrylate, 2-ethylhexyl acrylate, acrylic acid, 2-hydroxyethyl (meth)acrylate, methyl (meth)acrylate, styrene, glycidyl (meth)acrylate, isooctyl acrylate, stearyl methacrylate, dodecyl acrylate, decyl acrylate, vinyl acetate, acrylonitrile, etc. The copolymerized acryl-based resin may have a glass transition (Tg) temperature of about −60° C. to about 0° C., preferably about −40° C. to about −10° C. A Tg of about −60° C. to about 0° C. may help ensure desirable levels of adhesivity (tack) at room temperature. A Tg of about −40° C. or more may help provide the PSA film 4 with a good mix of strength and adhesion. A Tg temperature of about −10° C. or less may provide good adhesion at room temperature. The glass transition temperature of the acryl-based resin may be controlled by adjusting the particular monomers, and the relative proportions thereof, that are copolymerized.

The acryl-based resin preferably has at least one polar functional group, e.g., hydroxy, carboxyl, epoxy, amine, etc. Where the support film 5 is a nonpolar material like polyolefin film, the film surface may be modified to provide good affinity for the PSA film 4. It is possible, however, to improve the adhesion between the PSA film 4 and the support film 5 by introducing functional groups to the acryl-based resin used in the composition and/or performing a crosslinking reaction with a curing agent.

Examples of the polyester-based resin include materials such as Vylon®, Vylon® 280, and Vylon® 500, manufactured by Toyobo Co., Ltd. (Japan). Examples of the urethane-based resin include materials such as Vylon® UR-1350 and Vylon® UR-2300, manufactured by Toyobo Co., Ltd. (Japan). Examples of the silicone-based resin include materials such as DPSA200, PSA518, PSA529, and PSA595, manufactured by Dong Yang Silicone Co., Ltd. (Korea). Examples of the rubber-based resin include Nipol® DN003, Nipol® 1041, and Nipol® 1043, manufactured by the Zeon Corp. (Japan).

The polymer binder resin A preferably has a weight-average molecular weight of about 100,000 to about 2,000,000. A molecular weight of about 100,000 or more may provide a PSA composition that adheres tightly to the support film 5, which may help reduce or eliminate unintentional separation of the chips, chip cracks, etc., which may occur during dicing due to insufficient film cohesiveness. A molecular weight of about 2,000,000 or less may help ensure solubility, which may ease coating and other processing operations.

The UV-curing acrylate B may have a viscosity that is immeasurably high at room temperature (25° C.), i.e., it may be a solid or near-solid rather than a liquid, and may have a viscosity of about 10,000 cps or higher at 40° C. The UV-curing acrylate B may have a carbon-carbon double bond (C═C) that can be cured by UV light. The UV-curing acrylate B may be a urethane acrylate based oligomer. In an implementation, the urethane acrylate oligomer may be prepared by reacting a terminal isocyanate urethane prepolymer with an acrylate having a hydroxyl group. The terminal isocyanate urethane prepolymer may be obtained by reacting a polyester-type polyol compound or polyether-type polyol compound with a polyisocyanate compound.

In general, when a polymer binder resin is mixed with a UV-curing low molecular weight material, the adhesion force may not decrease significantly after UV curing if the low molecular weight material migrates to the adhesive layer. In particular, conventional UV-curing acrylates may exist in the liquid phase at room temperature, such that they are prone to migration. In contrast, in this embodiment, the UV-curing acrylate B may be used because the UV-curing acrylate B may be so viscous at room temperature that it is a solid or near-solid, thus inhibiting migration.

For example, the UV-curing acrylate B may be a low molecular weight acrylate, e.g., having a molecular weight of about 1,000, and may be so viscous at room temperature that it behaves like solid or near-solid, rather than a liquid, and may have a viscosity of about 10,000 cps or higher at 40° C. When mixed with the polymer resin A and coated on the support film 5, the UV-curing acrylate B may form a strongly attached film. Consequently, it may not migrate to the adhesive layer 3 before UV irradiation, and may exhibit a significant decrease in adhesion after UV irradiation, which may enable pick-up of the chips 6a.

The heat curing agent C may include one or more of, e.g., polyisocyanate, melamine/formaldehyde resin, or epoxy resin. The heat curing agent C may act as crosslinking agent and may react with a functional group of the polymer binder resin A. A three-dimensional network structure may be produced by the crosslinking. The heat curing agent C in combination with the PSA polymer resin A and the UV-curing acrylate B may form a strong film on the support film 5, which may not peel off during dicing, i.e., before UV irradiation. Where the support film 5 is a polyolefin film having no polar group, it may be difficult to attach nonpolar substance to the film surface. Therefore, as described above, corona treatment, primer treatment, etc., may be performed, which may increase surface polarity and surface tension. The effectiveness of such treatments, however, may be limited, and it may thus be desirable to adjust the basic polarity of the resin. Accordingly, it may be preferable to use a polymer binder resin A having a polar functional group, e.g., hydroxyl or carboxyl, with the heat curing agent C so as to form a strong film by crosslinking them.

The composition preferably includes about 0.01 to about 10 parts by weight of the heat curing agent C per 100 parts by weight of the polymer resin A. Using about 0.01 part by weight or more may avoid reductions in adhesion force with respect to the support film 5 due to low or negligible levels of crosslinking, which could result in the film layer peeling off after coating. Using about 10 parts by weight or less may help avoid reductions in tack before UV irradiation arising from excessive crosslinking, which may reduce the pressure sensitive adhesion to the ring frame, and cause detachment of the dicing die bonding film and the wafer from the ring frame during expanding.

The photopolymerization initiator D may include, e.g., benzophenone compounds such as benzophenone, 4,4′-dimethylaminobenzophenone, 4,4′-diethylaminobenzophenone, 4,4′-dichlorobenzophenone, etc., acetophenone compounds such as acetophenone, diethoxyacetophenone, etc., anthraquinone compounds such as 2-ethylanthraquinone, t-butylanthraquinone, etc. The composition may include about 0.1 to about 5 parts by weight of the photopolymerization initiator D per 100 parts by weight of the UV-curing acrylate B. Using about 0.1 part by weight or more may provide efficient radical generation upon UV irradiation, leading to a significant decrease in the adhesion force at the interface of the PSA film 4 and the adhesive layer 3 upon UV irradiation, and enabling chip pick-up for chips of various sizes. Using about 5 parts by weight or less may avoid waste of the photopolymerization initiator D, may avoid offensive odors, and may avoid reductions in reliability of the adhesive layer inside the packaging caused by migration of unreacted photopolymerization initiator D to the adhesive layer 3.

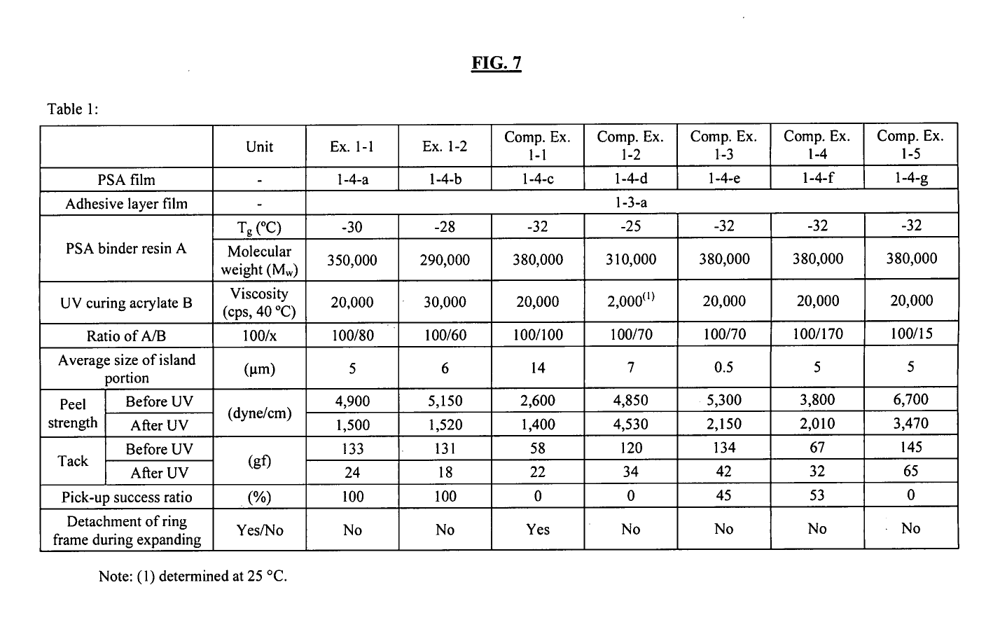

The composition according to the third embodiment may be used to produce the PSA film 4 according to the second embodiment, which may have a “sea-island” structure at the surface, as shown in FIG. 6, that is a result of phase incompatibility between the polymer binder resin A and the UV-curing acrylate B. Referring to FIG. 6, the “sea” is the portion where the polymer binder resin A exists, and the “islands” are the portions where the UV-curing acrylate B exists. The islands, i.e., the UV-curing acrylate B, may exhibit physical changes upon curing when irradiated with UV light. For example the islands may exhibit a reduction in volume, i.e., contract, and/or exhibit a phase change upon curing when irradiated with UV light. The sea portion, however, may not exhibit any significant changes due to the UV light irradiation. Accordingly, the total adhesivity exhibited by the sea-island structure may be reduced by the UV curing. The sea-island structure of the PSA film 4 may be viewed using, e.g., FE-SEM, or an optical microscope having a magnification power of about 3,000× or more.

The average size of the islands in the sea-island structure is preferably about 1 μm to about 10 μm. The island regions formed by the UV-curing acrylate B are easily peeled off at the interface with the adhesive layer 3 after curing (UV irradiation). In contrast, the sea portion corresponding to the polymer binder A is not cured by UV irradiation, such that the structure thereof is not changed. Thus, starting with a hypothetical case where the area of the sea portion and the combined areas of the islands the same, then the adhesivity of the sea-island structure will exhibit greater reductions upon UV curing as the relative size of the island portions become larger with respect to the size of the sea portion. That is, as the ratio of the area of the islands with respect to the area of the sea is increased, the structure may exhibit a more significant decrease in adhesivity upon UV curing. The ratio of the area of the islands with respect to the area of the sea may be varied by varying the amount and/or composition of the UV-curing acrylate B. The island size may depend on processing parameters such as film forming temperature, drying speed, and other parameters such as the molecular weights of the components.

If the sea-island structure of the PSA film has island regions with an average size of less than about 1 μm, the PSA film 4 and the adhesive layer 3 may be attached to one another with a very high level of adhesion. Therefore, a large amount of UV irradiation may be required to reduce the adhesion force of the PSA film 4 to the adhesive layer 3, which may generate heat. Excessive heat may fluidize the adhesive layer 3 laminated on the PSA film 4, thereby making pick-up, i.e., separation of the PSA film 4 from the adhesive layer 3, difficult. If the average size of the island regions is greater than about 10 μm, the PSA film 4 and the adhesive layer 3 may be loosely attached, and the peeling at the interface between the PSA film 4 and the adhesive layer 3 may occur with a small amount of UV irradiation. Unwanted peeling, however, may also occur before UV irradiation because of the weak attachment, which may result in separation of the PSA film 4, chip cracking or separation during cutting, etc. Also, if the average size of the island regions is greater than about 10 μm, adhesion force to the ring frame before UV irradiation may be reduced, such that detachment from the ring frame may occur while elongating (expanding) the dicing die bonding film 1 during die bonding. Accordingly, although large reductions in adhesivity upon UV curing may be exhibited by a structure having a large island area relative to the sea area, such a structure may exhibit low adhesion prior to UV curing, which may result in undesired separation, e.g., separation from the ring frame.

The PSA film 4 may have a thickness of about 3 μm to about 30 μm, preferably about 5 μm to about 20 μm. A thickness of about 3 μm or more may help ensure that the cohesiveness of the PSA film 4 after UV curing is high enough to result in a significant reduction in the adhesion force at the interface with the adhesive layer 3. A thickness of about 30 μm or less may help reduce or eliminate unwanted threads and scraps during dicing.

### Adhesive Layer 3

As described above, the dicing die bonding film 1 may be formed by coating the PSA film 4 on the support film 5, and then laminating the adhesive layer 3 thereon. A chip 6a, e.g., a semiconductor chip, optical chip, MEMS device, etc., may be attached to the adhesive layer 3. As the film is cleaved, the chip 6a and adhesive layer part 3a may be detached from the PSA film 4, and then die bonded on the surface of the support member 7, e.g., using a pick-up process. The adhesive layer 3 may be attached, e.g., at about 60° C., on one side (glass side) of the wafer 6, on which circuitry may be designed. After dicing, the chip 6a and the adhesive layer part 3a may be die bonded, e.g., at about 120° C., to the support member 7, which may be a lead frame, a PCB or another device, and then packaged using epoxy molding. Thus, the adhesive layer 3 may remain in the packaging even after epoxy molding and may affect the reliability of the package.

The adhesive layer 3 may be formed from a film-forming thermosetting resin having a high molecular weight. The adhesive layer 3 may include, e.g., an acryl-based copolymer, an epoxy resin, etc. Examples of the acryl-based copolymer include acrylic acid ester, methacrylic acid ester, and acryl rubber, which is a copolymer of acrylonitrile. The epoxy resins may be resins that cure and provide adhesive force, and may include two or more functional groups. Examples of the epoxy resin include bisphenol A epoxy resin, phenol novolac epoxy resin, cresol novolac epoxy resin, etc.

A curing promoter may be included in the adhesive layer 3 to promote the curing of the epoxy resin. The curing promoter may be imidazole-based, amine-based, etc. In addition, an organic filler, an inorganic filler, an adhesion promoter, a surfactant, an antistatic agent, etc., may be added to the adhesive layer 3, depending on the particular implementation. For example, various silane coupling agents may be used in the adhesive layer 3 in order to enhance the adhesion of the adhesive layer 3 to the wafer 6. Further, the inorganic layer 3 may include inorganic particles, e.g., silica, etc., to improve the dimensional stability and thermal resistance of the adhesive layer 3.

The thickness of the adhesive layer coating may be about 5 μm to about 100 μm, preferably about 10 μm to about 80 μm. As the thickness is increased, it may become more difficult to maintain a uniform thickness when bonding a chip 6a to another chip 6a, to the substrate 7, etc., which may result in fillet problems similar to those generated where a liquid adhesive is used. A thickness of about 5 μm or more may help ensure a desirable level of adhesion to the wafer 6. A thickness of about 100 microns or less may provide a package that is light, thin, and compact. As with the coating of the PSA film 4, the coating method used for the adhesive layer 3 may provide a uniform film thickness.

The following Examples are provided in order to set forth particular details of one or more example embodiments. However, it will be understood that the embodiments described herein are not limited to the particular details described in the Examples.

### EXAMPLE SET NO. 1

An adhesive layer film was prepared and adhered with respective PSA films to prepare dicing die bonding films, and the dicing die bonding films were tested by wafer mounting, dicing, and die bonding.

### Preparation of Adhesive Film

The following compounds were mixed to prepare an adhesive film (“adhesive film 1-3-a”):

Acryl resin (KLS-1046DR, hydroxyl value of 13 mg KOH/g, acid value of 63 mg KOH/g, Tg of 38° C., average molecular weight of 690,000, manufactured by Fujikura Kasei Co., Ltd. (Japan)), 400 g;

Acryl resin (WS-023, hydroxyl value or acid value of 20 mg KOH/g, Tg of −5° C., average molecular weight of 500,000, hydroxyl group or carboxyl group content of 20, manufactured by Nagase ChemteX Corp. (Japan)), 60 g;

Cresol novolac epoxy resin (YDCN-500-4P, molecular weight of 10,000 or less, manufactured by Kukdo Chemical Co., Ltd. (Korea)), 60 g;

Cresol novolac curing agent (MEH-7800SS, manufactured by Meiwa Plastic Industries (Japan)), 40 g;

Imidazole curing catalyst (2P4MZ, manufactured by Shikoku Chemicals Corp. (Japan)), 0.1 g;

Alkyl isocyanate trimethylolpropane modified pre-curing additive (L-45, manufactured by Nippon Polyurethane Industries (Japan)), 3 g;

Epoxy additive (E-5XM, manufactured by Soken Chemical & Engineering Co., Ltd. (Japan)), 1 g;

Mercapto silane coupling agent (KBM-803, manufactured by Shin-Etsu Chemical Co., Ltd. (Japan)), 0.5 g;

Epoxy silane coupling agent (KBM-303, manufactured by Shin-Etsu Chemical Co., Ltd. (Japan)), 0.5 g; and

Amorphous silica filler (OX-50, manufactured by Degussa GmbH (Germany)), 20 g.

The mixture was dispersed at 500 rpm for about 2 hours. After the dispersion, milling was carried out. Bead milling was performed, mainly using inorganic particles. Following the milling, the solution was coated on one side of a dried 38 μm-thick polyethylene terephthalate release film to a film thickness of 20 μm to produce the adhesive film 1-3-a. Then, a polyethylene terephthalate film was laminated thereon to protect the adhesive film 1-3-a.

### Preparation of PSA Films

### EXAMPLE 1-1

300 g of acryl based resin (PSA binder), having a solid content of 33%, a Tg of −30° C. and a weight-average molecular weight of 350,000, was mixed with 80 g of U-324A (Shin-Nakamura (Japan)), which had a viscosity that was immeasurable at room temperature and was 20,000 cps at 40° C. Then, 2 g of polyisocyanate curing agent (L-45, Nippon Polyurethane (Japan)) and 1 g of IC-651 (Ciba-Geigy, (Switzerland)) were added to prepare a light-curing composition. The light-curing composition was coated on one side of a 38 μm thick PET release film (MRF-38, Mitsubishi Polyester (Japan)) using an applicator. After drying at 100° C. for 2 minutes, a 100 μm thick polyolefin film (OGF-100, Osaka Godo (Japan)) was laminated by heating to 60° C. to obtain a PSA film 1-4-a. The prepared PSA film 1-4-a had island regions having an average size of 5 μm.

### EXAMPLE 1-2

300 g of acryl based resin (PSA binder), having a solid content of 33%, a Tg of −28° C. and a weight-average molecular weight 290,000, was mixed with 60 g of QU-1000 (urethane acrylate, Mw 1,800, manufactured by QNTOP-Korea), the viscosity of which was immeasurable at room temperature and was 30,000 cps at 40° C. Then, 2 g of polyisocyanate curing agent (L-45) and 1 g of IC-651 were added to prepare a light-curing composition. The light-curing composition was coated on one side of a 38 μm thick PET release film (MRF-38) using an applicator. After drying at 100° C. for 2 minutes, a 100 μm thick polyolefin film (OGF-100) was laminated by heating to 60° C. to obtain a PSA film 1-4-b. The prepared PSA film 1-4-b had island regions having an average size of 6 μm.

### COMPARATIVE EXAMPLE 1-1

300 g of acryl based resin (PSA binder), having a solid content of 33%, a Tg of −32° C. and a weight-average molecular weight 380,000, was mixed with 100 g of U-324A. Then, 2 g of polyisocyanate curing agent (L-45) and 1 g of IC-651 were added to prepare a light-curing composition. The light-curing composition was coated on one side of a 38 μm thick PET release film (MRF-38) using an applicator. After drying at 100° C. for 2 minutes, a 100 μm thick polyolefin film (OGF-100) was laminated by heating to 60° C. to obtain a PSA film 1-4-c. The prepared PSA film 1-4-c had island regions having an average size of 14 μm.

### COMPARATIVE EXAMPLE 1-2

300 g of acryl based resin (PSA binder), having a solid content of 33%, a glass transition temperature of −25° C. and a weight-average molecular weight 310,000, was mixed with 70 g of UA-4400 (Shin-Nakamura Chemical Co. (Japan)), which was a liquid having a viscosity at room temperature (25° C.) of 2,000 cps. Then, 2 g of polyisocyanate curing agent (L-45) and 1 g of IC-651 were added to prepare a light-curing composition. The light-curing composition was coated on one side of a 38 μm thick PET release film (MRF-38) using an applicator. After drying at 100° C. for 2 minutes, a 100 μm thick polyolefin film (OGF-100) was laminated by heating to 60° C. to obtain a PSA film 1-4-d. The prepared PSA film 1-4-d had island regions having an average size of 7 μm.

### COMPARATIVE EXAMPLE 1-3

300 g of acryl based resin (PSA binder), having a solid content of 33%, a Tg of −32° C. and a weight-average molecular weight 380,000, was mixed with 70 g of U-324A. Then, 2 g of polyisocyanate curing agent (L-45) and 1 g of IC-651 were added to prepare a light-curing composition. The light-curing composition was coated on one side of a 38 μm thick PET release film (MRF-38) using an applicator. After drying at 100° C. for 2 minutes, a 100 μm thick polyolefin film (OGF-100) was laminated by heating to 60° C. to obtain a PSA film 1-4-e. The prepared PSA film 1-4-e had island regions having an average size of 0.5 μm.

### COMPARATIVE EXAMPLE 1-4

300 g of acryl based resin (PSA binder), having a solid content of 33%, a Tg of −32° C. and a weight-average molecular weight 380,000, was mixed with 170 g of U-324A. Then, 2 g of polyisocyanate curing agent (L-45) and 1 g of IC-651 were added to prepare a light-curing composition. The light-curing composition was coated on one side of a 38 μm thick PET release film (MRF-38) using an applicator. After drying at 100° C. for 2 minutes, a 100 μm thick polyolefin film (OGF-100) was laminated by heating to 60° C. to obtain a PSA film 1-4-f. The prepared PSA film 1-4-f had island regions having an average size of 5 μm.

### COMPARATIVE EXAMPLE 1-5

300 g of acryl based resin (PSA binder), having a solid content of 33%, a Tg of −32° C. and a weight-average molecular weight 380,000, was mixed with 15 g of U-324A. Then, 2 g of polyisocyanate curing agent (L-45) and 1 g of IC-651 were added to prepare a light-curing composition. The light-curing composition was coated on one side of a 38 μm thick PET release film (MRF-38) using an applicator. After drying at 100° C. for 2 minutes, a 100 μm thick polyolefin film (OGF-100) was laminated by heating to 60° C. to obtain a PSA film 1-4-g. The prepared PSA film 1-4-g had island regions having an average size of 5 μm.

### Tests of Physical Properties of Dicing Die Bonding Films

Physical properties of the dicing die bonding films, prepared from the adhesive film 1-3-a and the PSA films of Examples 1-1 and 1-2 (PSA films 1-4-a and 1-4-b), and Comparative Examples 1-1 through 1-5 (PSA films 1-4-c through 1-4-g), were measured as follows.

### Average Size of Island Regions in Sea-Island Structure

Surface photographs of the PSA films prepared in the first set of Examples and Comparative Examples were taken using a FE-SEM S-4800 (Hitachi High Technologies America, Inc. (USA)) at 5,000× magnification. The average size of the island regions was measured by analyzing the photographs.

### Weight-Average Molecular Weight of Polymer Binder Resin A

Gel permeation chromatography (150-C ALC/GPC, Waters Corp. (USA)) was performed on a 1% solution obtained by dissolving the polymer binder resin A in tetrahydrofuran. Polystyrene-converted weight-average molecular weight was calculated from the measurement result.

### Glass Transition Temperature of Polymer Binder Resin A

Using about 5 mg to about 10 mg of the binder resin A having adhesive property, glass transition temperature was measured using a DSC2910 (TA Instruments (USA)), while increasing the temperature from −70° C. to 200° C. at a rate of 10° C./min.

### 180° Peel Strength Between PSA Film and Adhesive Layer (Before and After UV Curing)

180° peel strength between the respective PSA films and the adhesive layer was measured according to the procedure JIS Z0237. The dicing die bonding film samples prepared in the first set of Examples and Comparative Examples were cut to a size of 15 mm×100 mm. Each sample was tested using a tensile strength tester (Series 1X/s Automated Materials Tester 3343, Instron Corp. (USA)) at 10 N load cell, at a rate of 300 mm/min. UV irradiation was performed using an AR 08 UV equipment (manufactured by AARON Co.) at 70 W/cm for 2 seconds. The UV exposure amount was 140 mJ/cm². 10 samples were tested and averaged for each Example and Comparative Example, before and after UV irradiation.

### Tackiness of PSA Films (Before and After UV Curing)

The PSA films of the dicing die bonding films prepared in the first set of Examples and Comparative Examples were measured before and after UV curing using a probe tack tester (Chemilab Tack Tester, manufactured by Chemilab (Korea)). Following the procedure ASTM D2979-71, the tip of a clean probe was contacted on the surface of the PSA for 1.0+0.01 sec at a rate of 10+0.1 mm/sec and a contact load of 9.79+1.01 kPa, and the maximum force required was measured. UV irradiation was performed using an AR 08 UV at 70 W/cm for 2 seconds. UV exposure amount was 140 mJ/cm². 5 samples were tested and averaged for each Example and Comparative Example, before and after UV irradiation.

### Pick-Up Success Ratio

An 80 μm thick silicon wafer was attached to each of the dicing die bonding films prepared in the first set of Examples and Comparative Examples by applying heat and pressure for 10 seconds at 60° C. Then, after dicing to a size of 16 mm×9 mm using a DFD-650 (DISCO Corp. (Japan)), UV irradiation was performed using an AR 08 UV at 70 W/cm for 2 seconds. UV exposure amount was 140 mJ/cm². After UV irradiation, the pick-up test was performed at the center of the silicon wafer for 200 chips, using a die bonder (SDB-10M, manufactured by Samsung Mechatronics (Korea)).

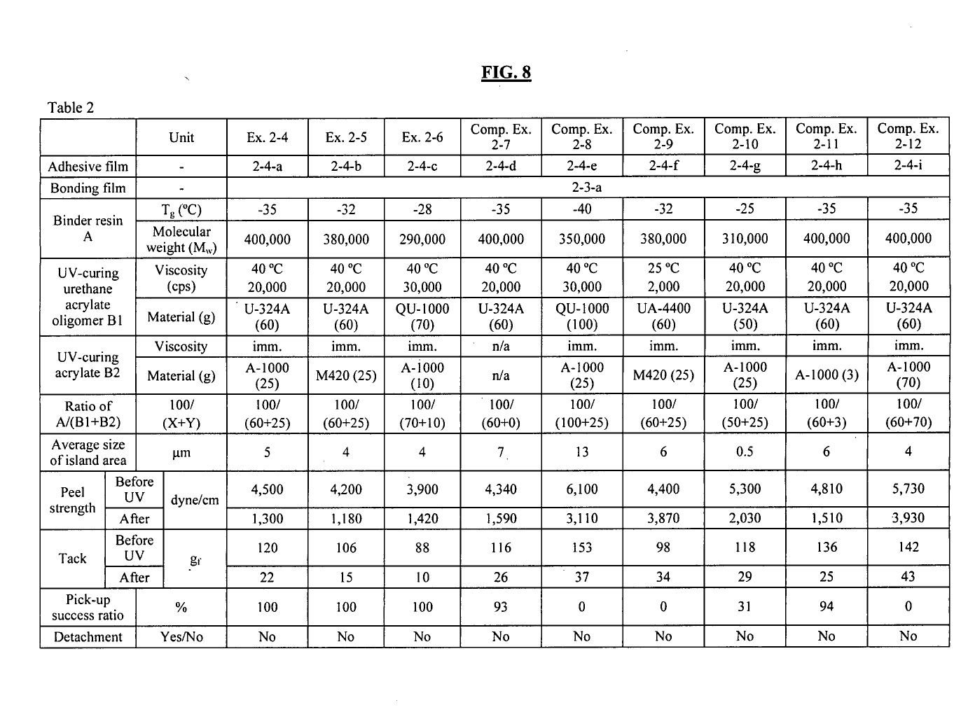

The test results for the physical properties evaluated as set forth above are given in Table 1 illustrated in FIG. 7. For Examples 1-1 and 1-2, a 100% pick-up success ratio was attained for the 16 mm×9 mm sized chips. For Comparative Example 1-1, pick-up was not even attempted because of detachment from the ring frame during expanding, the average size of the island regions was greater than 10 μm, and peeling strength and tack before UV irradiation were low. For Comparative Example 1-2, the UV-curing acrylate B was liquid at room temperature. When the PSA film 1-4-c was formed, the fluid acrylate migrated to the adhesive layer, the adhesion force was essentially unchanged after UV irradiation, and the pick-up success ratio was 0%. For Comparative Example 1-3, the pick-up success ratio was low, the average size of the island regions was less than 1 μm, and the adhesion force did not decrease significantly at the interface of the PSA film and the adhesive layer. In Comparative Examples 1-4 and 1-5, the content ratio of the PSA polymer binder A and the UV-curing acrylate B was 100/170 and 100/15, respectively. In Comparative Example 1-4, where the content of the UV-curing acrylate B was 170 parts by weight per 100 parts by weight of the PSA polymer binder A, the peel strength and tack were low before UV irradiation, the decrease of peel strength after UV irradiation was low, and the pick-up success ratio was low. For Comparative Example 1-5, which had a pick-up success ratio of 0%, the content of the UV-curing acrylate B was low and the decrease of peel strength after UV irradiation was also low.

A dicing die bonding film 1′ according to a fourth embodiment may be formed using a PSA film 4′ according to a fifth embodiment. The dicing die bonding film 1′ and the PSA film 4′ may have the same structure as the dicing die bonding film 1 and the PSA film 4 illustrated in FIG. 1, and may be employed in a similar fashion in a manufacturing process. The PSA film 4′ may be formed using a PSA composition according to a sixth embodiment, details of which will now be described. The following description sets forth details of the fourth through sixth embodiments. However, details of materials and structures that are substantially the same as those described above may be omitted in order to avoid repetition.

The PSA composition according to the sixth embodiment may include the adhesive polymer binder A, a UV-curing urethane acrylate oligomer B1, a UV-curing acrylate B2, the heat curing agent C, and the photopolymerization initiator D. The UV-curing urethane acrylate oligomer B1 may have a viscosity that is immeasurably high at room temperature, i.e., it may be a solid or near-solid at room temperature, and may have a viscosity of about 10,000 cps or more at 40° C. The UV-curing acrylate B2 may be a solid or wax and may have a melting point above about 25° C.

In combination with the polymer binder resin A, the UV-curing acrylates B1 and B2 may induce crosslinking between the polymer binder resin A and the UV-curing acrylates B1 and B2, thereby resulting in significant decrease of bonding force after UV irradiation.

The UV-curing acrylate B2 may form a strong film in the adhesive binder when mixed with the polymer resin A and coated on the support film 5, and thus migration to the adhesive layer 3 may not occur before UV irradiation. Consequently, the bonding force of the PSA layer 4′ with respect to the adhesive layer 3 may decrease significantly upon UV irradiation. Further, migration to the adhesive layer 3 may be prevented due to the high viscosities of the UV-curing urethane acrylate oligomer B1 and the UV-curing acrylate B2, even when they are low-molecular-weight materials, e.g., having molecular weights of about 1,000. Accordingly, the bonding force at the interface between the PSA film 4′ and the adhesive layer 3 may decrease significantly upon UV irradiation.

The PSA composition according to the sixth embodiment may be used to produce the PSA film 4′ having a “sea-island” structure at the surface, as shown in FIG. 6. The sea-island structure may be produced due to phase incompatibility between the polymer binder resin A and the low-molecular-weight UV-curing acrylates. In particular, referring to FIG. 6, in the PSA film 4′ according to the fifth embodiment, the “islands” may be formed by the UV-curing urethane acrylate oligomer B1, and the “sea” area may be formed by the polymer binder resin A. The UV-curing acrylate B2 may exist in the sea area with the binder resin A, and/or in the island areas with the UV-curing urethane acrylate oligomer B1.

The average size of the islands may be about 1 μm to about 10 μm. As discussed above in connection with the first embodiment, after UV irradiation, the island regions formed by the UV-curing acrylates B1 may exhibit a significant decrease in shrinkage and tack as compared to the sea area, thereby enabling peeling at the interface with the adhesive layer 3. Upon UV irradiation, the polymer binder resin A and the UV-curing acrylates B2 combine to form an inter-penetration network structure, thereby increasing the Tg of the polymer binder resin A and decreasing the tack of the PSA film 4′. If the average size of the islands is less than about 1 μm , a large amount of UV irradiation may be required to decrease the bonding force at the interface with the adhesive layer 3, because the contact area of the PSA film 4′ and the adhesive layer 3 may be large. If the average size of the islands is greater than about 10 μm, the PSA film 4′ and the adhesive layer 3 may be loosely attached, and the peeling at the interface between the PSA film 4 and the adhesive layer 3 may occur with a small amount of UV irradiation. The sea-island structure of the PSA film 4′ may be viewed using, e.g., FE-SEM, or an optical microscope having a magnification power of about 3,000× or more. In an implementation, the PSA composition according to the sixth embodiment may include the polymer binder A, about 20 parts to about 150 parts by weight of the UV-curing urethane acrylate oligomer B1, per 100 parts by weight of the polymer binder A, and about 5 parts to about 50 parts by weight of the UV-curing acrylate B2, per 100 parts by weight of the polymer binder A. The UV-curing urethane acrylate oligomer B1 may be a solid or near-solid at room temperature, and may have a viscosity of about 10,000 cps or more at 40° C. The UV-curing acrylate B2 may be a solid or wax with a melting point above 25° C. The UV-curing acrylate B2 may include one or more of trimethylolpropane tri(meth)acrylate, pentaerythritol tetraacrylate, tris(2-acryloxyethyl)isocyanulate, methoxy polyethyleneglycol 1000 methacrylate, methoxy polyethyleneglycol 1000 acrylate, behenyl acrylate, polyethyleneglycol 1000 dimethacrylate, polyethyleneglycol 1000 diacrylate, or tetramethylolmethane tetraacrylate.

When the UV-curing urethane acrylate oligomer B1 is added in an amount of less than about 20 parts by weight, the decrease in bonding force may be relatively small due to the small absolute amount cured by UV light. When the UV-curing urethane acrylate oligomer B1 is added in an amount of more than about 150 parts by weight, a film may not be formed (before UV irradiation) due to poor film cohesiveness. When the UV-curing acrylate B2 is used in an amount of less than about 5 parts by weight, the UV light-induced increase in cohesive force and decrease in tack may be low, due to the small absolute amount cured by the UV light. When the UV-curing acrylate B2 is used in an amount of more than about 50 parts by weight, the absolute amount cured by UV may be good, but some unreacted UV-curing acrylate B2 may migrate to the adhesive layer 3, which may significantly reduce the UV light-induced decrease in bonding force, or even increase the bonding force after UV irradiation.

The PSA composition may further include about 0.1 parts to about 10 parts by weight of the heat curing agent C, per 100 parts by weight of the polymer binder A, and about 0.1 parts to about 5 parts by weight of a photopolymerization initiator D, per 100 parts by weight of the combined acrylates B1 and B2, i.e., about 0.1 parts to about 5 parts by weight based on the weight of the UV-curing urethane acrylate oligomer B1 plus the weight of the UV-curing acrylate B2.

Acryl resins may be used for the polymer binder resin A. Various other resins, e.g., polyester resins, urethane resins, silicone resins and natural rubber resins, may also be used for the polymer binder resin A. In the acryl resins, the monomers used for copolymerization may include one or more of, e.g., butyl acrylate, 2-ethylhexyl acrylate, acrylic acid, 2-hydroxyethyl (meth)acrylate, methyl (meth)acrylate, styrene, glycidyl (meth)acrylate, isooctyl acrylate, stearyl methacrylate, dodecyl acrylate, decyl acrylate, vinyl acetate, acrylonitrile, etc.

The UV-curing acrylates B1 and B2 included in the PSA composition may have carbon-carbon double bonds (C═C) that can be cured by UV light, e.g., trimethylolpropane triacrylate, tetra ethylolmethane tetraacrylate, pentaerythritol hexaacrylate, pentaerythritol tetraacrylate, dipentadierythritol monohydroxypentaacrylate, dipentaerythritol hexaacrylate, 1,4-butyleneglycol diacrylate, 1,6-hexanediol diacrylate, polyethyleneglycol diacrylate, oligoester acrylate, etc.

The UV-curing urethane acrylate oligomer B1 may be one or more acrylates having a high viscosity at room temperature (25° C.), such that they behave like solids or near-solids, and may have viscosities of about 10,000 cps or more at 40° C. In an implementation, the UV-curing urethane acrylate oligomer B1 may be prepared by reacting a terminal isocyanate urethane prepolymer with a hydroxyacrylate, i.e., an acrylate having a hydroxyl group. The terminal isocyanate urethane prepolymer may be obtained by reacting a polyester-type polyol compound or polyether-type polyol compound with a polyisocyanate compound.

The UV-curing acrylate B2 may be one or more acrylates each having a high viscosity at room temperature, such that they behave like solids or wax with a melting point above about 25° C. The UV-curing acrylate B2 may have a weight-average molecular weight of about 100 to about 5,000. In an implementation, the UV-curing acrylate B2 may include one or more of trimethylolpropane tri(meth)acrylate, pentaerythritol tetraacrylate, tris(2-acryloxyethyl)isocyanulate, methoxy polyethyleneglycol 1000 methacrylate, methoxy polyethyleneglycol 1000 acrylate, behenyl acrylate, polyethyleneglycol 1000 dimethacrylate, polyethyleneglycol 1000 diacrylate, or tetramethylolmethane tetraacrylate. During UV irradiation, the trimethylolpropane tri(meth)acrylate UV-curing acrylate B2 may increase curing efficiency, as compared to when the urethane acrylate oligomer B1 is cured alone.

### EXAMPLE SET NO. 2

An adhesive layer film was prepared and adhered with respective PSA films to prepare dicing die bonding films, and the dicing die bonding films were tested by wafer mounting, dicing, and die bonding.

### Preparation of Adhesive Film

An adhesive film (“adhesive film 2-3-a”) was prepared as follows.

The following compounds were mixed and dispersed at 500 rpm for about 2 hours:

400 g of acryl resin KLS-1046DR (hydroxyl value=13 mg KOH/g, acid value=63 mg KOH/g, Tg=38° C., average molecular weight=690,000, manufactured by Fujikura Kasei Co., Ltd. (Japan));

60 g of WS-023 (hydroxyl value or acid value=20 mg KOH/g, Tg=−5° C., average molecular weight=500,000, hydroxyl or carboxyl content=20, manufactured by Nagase ChemteX Corp. (Japan));

60 g of cresol novolac epoxy resin YDCN-500-4P (molecular weight=10,000 or smaller, manufactured by Kukdo Chemical Co., Ltd. (Korea));

40 g of cresol novolac curing agent MEH-7800SS (manufactured by Meiwa Plastic Industries (Japan));

0.1 g of imidazole curing catalyst 2P4MZ (Saguk Chemical);

3 g of alkyl isocyanate, trimethylolpropane modified pre-curing additive L-45;

1 g of epoxy additive E-5XM (manufactured by Soken Chemical & Engineering Co., Ltd. (Japan));

0.5 g of mercaptosilane coupling agent KBM-803 (manufactured by Shin-Etsu Chemical Co., Ltd. (Japan));

0.5 g of epoxy silane coupling agent KBM-303 (manufactured by Shin-Etsu Chemical Co., Ltd. (Japan)); and

20 g of amorphous silica filler (OX-50, manufactured by Degussa GmbH (Germany)).

Milling was followed by dispersing. Bead milling was carried out using inorganic particles. After the milling was completed, coating was performed on one side of a 38 μm-thick polyethylene terephthalate release film to a thickness of 20 μm. The adhesive film 2-3-a was finished by laminating a polyethylene terephthalate film on the coating layer to protect the surface.

### Preparation of PSA Compositions

### EXAMPLE 2-1

### Preparation of Photocuring Composition

A photocuring composition was prepared by mixing the following components in a 1 L beaker: 300 g of an adhesive binder having a solid content of 33%, a Tg temperature of −35° C. and a weight-average molecular weight of 400,000; 60 g of U-324A (Shin-Nakamura Chemical (Japan)) having a viscosity that was immeasurably high at room temperature, and 20,000 cps at 40° C.; and 25 g of A-1000 (Shin-Nakamura Chemical), which was solid at room temperature with a melting point about 38° C. 2 g of polyisocyanate curing agent L-45 (Nippon Polyurethane Industry (Japan)) and 1 g of IC-184 (Ciba-Geigy (Switzerland)) were then added.

### EXAMPLE 2-2

### Preparation of Photocuring Composition

A photocuring composition was prepared by mixing the following components in a 1 L beaker: 300 g of an adhesive binder having a solid content of 33%, a Tg of −32° C. and a weight-average molecular weight of 380,000; 60 g of U-324A; and 25 g of Miramer M420 (Miwon Commercial Co., Ltd. (Korea)), which was solid at room temperature with a melting temperature about 37° C. 2 g of polyisocyanate curing agent L-45 and 1 g of IC-184 were then added.

### EXAMPLE 2-3

### Preparation of Photocuring Composition

A photocuring composition was prepared by mixing the following components in a 1 L beaker: 300 g of an adhesive binder having a solid content of 33%, a Tg of −28° C. and a weight-average molecular weight of 290,000; 70 g of QU-1000 (Q & Top) having a viscosity which was immeasurably high at room temperature and 30,000 cps at 40° C.; and 10 g of A-1000 (Shin-Nakamura Chemical (Japan)), which was solid at room temperature. 2 g of polyisocyanate curing agent L-45 and 1 g of IC-184 were then added.

### COMPARATIVE EXAMPLE 2-1

### Preparation of Photocuring Composition

A photocuring composition was prepared by mixing the following components in a 1 L beaker: 300 g of an adhesive binder having a solid content of 33%, a Tg of −35° C. and a weight-average molecular weight of 400,000; and 60 g of U-324A. 2 g of polyisocyanate curing agent L-45 and 1 g of IC-184 were then added.

### COMPARATIVE EXAMPLE 2-2

### Preparation of Photocuring Composition

A photocuring composition was prepared by mixing the following components in a 1 L beaker: 300 g of an adhesive binder having a solid content of 33%, a Tg of −40° C. and a weight-average molecular weight of 350,000; 100 g of QU-1000; and 25 g of A-1000. 2 g of polyisocyanate curing agent L-45 and 1 g of IC-184 were then added.

### COMPARATIVE EXAMPLE 2-3

### Preparation of Photocuring Composition

A photocuring composition was prepared by mixing the following components in a 1 L beaker: 300 g of an adhesive binder having a solid content of 33%, a Tg of −32° C. and a weight-average molecular weight of 380,000; 60 g of UA-4400 (Shin-Nakamura Chemical (Japan)) having a viscosity that was measurable at room temperature, i.e., 2,000 cps at 25° C.; and 25 g of Miramer M420. 2 g of polyisocyanate curing agent L-45 and 1 g of IC-184 were then added.

### COMPARATIVE EXAMPLE 2-4

### Preparation of Photocuring Composition

A photocuring composition was prepared by mixing the following components in a 1 L beaker: 300 g of an adhesive binder having a solid content of 33%, a Tg of −25° C. and a weight-average molecular weight of 310,000; 50 g of U-324A; and 25 g of A-1000. 2 g of polyisocyanate curing agent L-45 and 1 g of IC-184 were then added.

### COMPARATIVE EXAMPLE 2-5

### Preparation of Photocuring Composition

A photocuring composition was prepared by mixing the following components in a 1 L beaker: 300 g of an adhesive binder having a solid content of 33%, a Tg of −35° C. and a weight-average molecular weight of 400,000; 60 g of U-324A; and 3 g of A-1000. 2 g of polyisocyanate curing agent L-45 and 1 g of IC-184 were then added.

### COMPARATIVE EXAMPLE 2-6

### Preparation of Photocuring Composition

A photocuring composition was prepared by mixing the following components in a 1 L beaker: 300 g of an adhesive binder having a solid content of 33%, a Tg of −35° C. and a weight-average molecular weight of 400,000; 60 g of U-324A; and 70 g of A-1000. 2 g of polyisocyanate curing agent L-45 and 2 g of IC-184 were then added.

### Preparation of Dicing Die Bonding Films

### EXAMPLE 2-4

### Preparation of Dicing Die Bonding Film

A 10 μm-thick PSA film 2-4-a was prepared by coating the photocuring PSA composition prepared in Example 2-1 on one side of a polyolefin film and drying. A dicing die bonding film was prepared by peeling off the polyethylene terephthalate film at one side of the adhesive film 2-3-a and laminating the adhesive film 2-3-a with the PSA film 2-4-a at room temperature, as illustrated in FIG. 1.

### EXAMPLE 2-5

### Preparation of Dicing Die Bonding Film

A dicing die bonding film was prepared as set forth above in Example 2-4, with the exception of preparing a PSA film 2-4-b using the photocuring composition prepared in Example 2-2.

### EXAMPLE 2-6

### Preparation of Dicing Die Bonding Film

A dicing die bonding film was prepared as set forth above in Example 2-4, with the exception of preparing an PSA film 2-4-c using the photocuring composition prepared in Example 2-3.

### COMPARATIVE EXAMPLE 2-7

### Preparation of Dicing Die Bonding Film

A dicing die bonding film was prepared as set forth above in Example 2-4, with the exception of preparing an PSA film 2-4-d using the photocuring composition prepared in Comparative Example 2-1.

### COMPARATIVE EXAMPLE 2-8

### Preparation of Dicing Die Bonding Film

A dicing die bonding film was prepared as set forth above in Example 2-4, with the exception of preparing an PSA film 2-4-e using the photocuring composition prepared in Comparative Example 2-2.

### COMPARATIVE EXAMPLE 2-9

### Preparation of Dicing Die Bonding Film

A dicing die bonding film was prepared as set forth above in Example 2-4, with the exception of preparing an PSA film 2-4-f using the photocuring composition prepared in Comparative Example 2-3.

### COMPARATIVE EXAMPLE 2-10

### Preparation of Dicing Die Bonding Film

A dicing die bonding film was prepared as set forth above in Example 2-4, with the exception of preparing an PSA film 2-4-g using the photocuring composition prepared in Comparative Example 2-4.

### COMPARATIVE EXAMPLE 2-11

### Preparation of Dicing Die Bonding Film

A dicing die bonding film was prepared as set forth above in Example 2-4, with the exception of preparing an PSA film 2-4-h using the photocuring composition prepared in Comparative Example 2-5.

### COMPARATIVE EXAMPLE 2-12

### Preparation of Dicing Die Bonding Film

A dicing die bonding film was prepared as set forth above in Example 2-4, with the exception of preparing an PSA film 2-4-i using the photocuring composition prepared in Comparative Example 2-6.

### Tests of Physical Properties of Dicing Die Bonding Films

### Average Size of Island Regions in Sea-Island Structure

Photographs of the surfaces of the PSA films prepared in the second set of Examples and Comparative Examples, i.e., Examples 2-4 through 2-6 and Comparative Examples 2-7 through 2-12, were taken at 5000× using FE-SEM S-4800 (Hitachi (Japan)), and the average sizes of the islands were measured. Results are given in Table 2 of FIG. 8.

### Weight-Average Molecular Weight of Polymer Binder Resin A

The polymer binder resins A prepared in the preparation of the photocuring compositions according to Examples 2-1 through 2-3 and Comparative Examples 2-1 through 2-6 were dissolved in tetrahydrofuran to obtain 1% solutions. Gel permeation chromatography (150-C ALC/GPC, Waters (U.S.A.) was carried out, and the polystyrene-converted weight-average molecular weight was calculated. Results are given in Table 2.

### Glass Transition Temperature of Polymer Binder Resin A

For each about 5 mg to about 10 mg of the polymer binder resins A prepared in the preparation of the photocuring compositions according to Examples 2-1 through 2-3 and Comparative Examples 2-1 through 2-6, Tg was measured using DSC2910 (TA) up to the second (2^{nd}) scan from −70° C. to 200° C., at a heating rate of 10° C./min. Results are given in Table 2.

### 180° Peel Strength Between PSA Film and Adhesive Layer (Before and After UV Curing)

180° peel strength between the PSA film and the adhesive layer was measured according to JIS Z0237. Samples of the dicing die bonding films prepared in Examples 2-4 through 2-6 and Comparative Examples 2-7 through 2-12 were cut to a size of 15 mm×100 mm, and each sample was peeled at a rate of 300 mm/min using an Instron Series 1X/s Automated Materials Tester-3343 at 10N Load Cell. The load required for the peeling was measured. Results are given in Table 2.

UV irradiation was performed for 2 seconds using AR 08 UV (Aaron) at a luminance of 70 W/cm² and an irradiation amount of 140 mJ/cm². Ten (10) measurements were made for each sample, both before and after UV irradiation, and the averages were taken.

### Tackiness of PSA Films (Before and After UV Curing)

For the dicing die bonding films prepared in Examples 2-4 through 2-6 and Comparative Examples 2-7 through 2-12, tackiness was measured (for the PSA films only), both before and after UV curing, using a probe tack tester (Chemilab Tack Tester). Measurements were made according to ASTM D2979-71. The clean tip of the probe was contacted at the surface of the PSA film for 1.0+0.1 sec, at a rate of 10+0.1 mm/sec and a contact load of 9.79+1.01 kPa. Then, the force required to detach from the surface was measured. Results are given in Table 2.

UV irradiation was performed for 2 seconds using AR 08 UV (Aaron) at a luminance of 70 W/cm² and an irradiation amount of 140 mJ/cm². Five (5) measurements were made for each sample, both before and after UV irradiation, and the averages were taken.

### Pick-Up Success Ratio

A 80 μm-thick silicon wafer was thermally bonded at 60° C. for 10 seconds to each of the dicing die bonding films prepared in Examples 2-4 through 2-6 and Comparative Examples 2-7 through 2-12. Subsequently, dicing was performed to a size of 16 mm×9 mm using EFD-650 (DISCO Corp. (Japan)). Then, UV irradiation was performed for 2 seconds using AR 08 UV (Aaron) at a luminance of 70 W/cm² and an irradiation amount of 140 mJ/cm². After UV irradiation, 200 chips were picked up at the center of the silicon wafer using a die bonder (SDB-10M, Samsung Mechatronics (Korea)) and the success ratio (%) was measured. Results are given in Table 2.

As illustrated in Table 2, the photocuring compositions of Examples 2-4 through 2-6, which included the polymer binder A, the low-molecular-weight UV-curing acrylates B1 and B2, the heat curing agent C, and the photopolymerization initiator D, a pick-up success ratio of 100% was attained for chips with a size of 16 mm×9 mm.

In contrast, a pick-up success ratio of 100% was not attained for Comparative Example 2-7, in which the UV-curing acrylate B2 was not included, because peel strength and tack were higher than Examples 2-4 through 2-6 after UV irradiation. Comparative Example 2-8, which had an average island size of greater than 10 μm, exhibited a pick-up success ratio of 0% because peel strength and tack were very high before and after UV irradiation. Comparative Example 2-9, having the UV-curing acrylate B2 for which the viscosity was measurable at room temperature, exhibited a pick-up success ratio of 0% because the bonding force did not decrease at all after UV irradiation due to the acrylate migrating from the PSA film to the adhesive layer. Comparative Example 2-10, which had an average island size of less than 1 μm, exhibited a low pick-up success ratio because the bonding force did not decrease significantly at the interface of the PSA film and the adhesive layer. Comparative Example 2-11, in which 3 parts by weight of the low-molecular-weight UV-curing acrylate B2 was included per 100 parts by weight of the polymer binder resin A, exhibited a result similar to that of Comparative Example 2-7, from which the low-molecular-weight UV-curing acrylate B2 was omitted, as the improvement of cohesive force and decrease of tack were insignificant after UV irradiation due to a small absolute amount cured by UV light. Comparative Example 2-12, in which 70 parts by weight of the low-molecular-weight UV-curing acrylate B2 were included per 100 parts by weight of the polymer binder resin A, exhibited a pick-up success ratio of 0% because peel strength and tack did not decrease significantly after UV irradiation.

As described above, a composition according to an embodiment may be used to form a PSA film of a dicing die bonding film. Little or no migration to the adhesive layer may occur, and the adhesion force at the interface between the PSA film and the adhesive layer may decrease significantly after UV irradiation. In an embodiment, the composition may include an acryl PSA binder and a UV-curing acrylate. The composition may be used to prepare a dicing die bonding film that provides superior pick-up performance even for large-sized chips, e.g., 10 mm×10 mm or larger.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A composition, comprising:
a polymer binder resin A;
a UV-curing acrylate B;
a heat curing agent C; and
a photopolymerization initiator D, wherein:
the composition includes about 20 to about 150 parts by weight of the UV-curing acrylate B per 100 parts by weight of the polymer binder resin A, and the UV-curing acrylate B is a solid or near-solid at room temperature and has a viscosity of about 10,000 cps or more at 40° C.

2. The composition as claimed in claim 1, wherein:
the composition includes about 0.1 to about 10 parts by weight of the heat curing agent C per 100 parts by weight of the polymer binder resin A, and the composition includes about 0.1 to about 5 parts by weight of the photopolymerization initiator D per 100 parts by weight of the UV-curing acrylate B.

3. The composition as claimed in claim 2, wherein the heat curing agent C includes one or more of a polyisocyanate, a melamine/formaldehyde resin, or an epoxy resin.

4. The composition as claimed in claim 3, wherein the photopolymerization initiator D includes one or more of a benzophenone compound, an acetophenone compound, or an anthraquinone compound.

5. The composition as claimed in claim 1, wherein the polymer binder resin A is an acryl resin having one or more of a hydroxy functional group, a carboxyl functional group, an epoxy functional group, or an amine functional group.

6. The composition as claimed in claim 5, wherein the acryl resin has a glass transition temperature of about −60° C. to about 0° C. and a weight-average molecular weight of about 100,000 to about 2,000,000.

7. The composition as claimed in claim 5, wherein the UV-curing acrylate B is a urethane acrylate oligomer.

8. A composition, comprising:
a polymer binder resin A;
a UV-curing urethane acrylate oligomer B1;
a UV-curing acrylate B2;
a heat curing agent C; and
a photopolymerization initiator D, wherein:
the composition includes about 20 parts to about 150 parts by weight of the UV-curing urethane acrylate oligomer B1, per 100 parts by weight of the polymer binder resin A,
the composition includes about 5 parts to about 50 parts by weight of the UV-curing acrylate B2, per 100 parts by weight of the polymer binder resin A, and the UV-curing urethane acrylate oligomer B1 is a solid or near-solid at room temperature and has a viscosity of about 10,000 cps or more at 40° C., and the UV-curing acrylate B2 is a solid or wax and has a melting point above about 25° C.

9. The composition as claimed in claim 8, wherein the UV-curing urethane acrylate oligomer B1 includes a copolymer of a terminal isocyanate urethane prepolymer and a hydroxy acrylate.

10. The composition as claimed in claim 9, wherein the UV-curing acrylate B2 includes one or more of trimethylolpropane tri(meth)acrylate, pentaerythritol tetraacrylate, tris(2-acryloxyethyl)isocyanulate, methoxy polyethyleneglycol 1000 methacrylate, methoxy polyethyleneglycol 1000 acrylate, behenyl acrylate, polyethyleneglycol 1000 dimethacrylate, polyethyleneglycol 1000 diacrylate, or tetramethylolmethane tetraacrylate.

11. The composition as claimed in claim 10, wherein the UV-curing acrylate B2 includes one or more acrylates, each of which is a solid or wax at room temperature and has a melting point above 30° C.

12. The composition as claimed in claim 8, wherein the polymer binder resin A is an acryl resin having one or more of a hydroxy functional group, a carboxyl functional group, an epoxy functional group, or an amine functional group.

13. A dicing die bonding film, comprising:
a support film;
an adhesive layer on the support film; and
a pressure sensitive adhesive film on the adhesive layer, wherein:
the pressure sensitive adhesive film includes:
a polymer binder resin A;
a UV-curing acrylate B;
a heat curing agent C; and
a photopolymerization initiator D,
the pressure sensitive adhesive film includes about 20 to about 150 parts by weight of the UV-curing acrylate B per 100 parts by weight of the polymer binder resin A, and
the UV-curing acrylate B is a solid or near-solid at room temperature and has a viscosity of about 10,000 cps or more at 40° C.

14. The dicing die bonding film as claimed in claim 13, wherein the polymer binder resin A is an acryl resin having one or more of a hydroxy functional group, a carboxyl functional group, an epoxy functional group, or an amine functional group.

15. The dicing die bonding film as claimed in claim 14, wherein the acryl resin has a glass transition temperature of about −60° C. to about 0° C. and a weight-average molecular weight of about 100,000 to about 2,000,000.

16. The dicing die bonding film as claimed in claim 14, wherein the UV-curing acrylate B is a urethane acrylate oligomer.

17. The dicing die bonding film as claimed in claim 14, wherein the adhesive layer includes an acryl resin.

18. The dicing die bonding film as claimed in claim 13, wherein the pressure sensitive adhesive film has a sea-island structure in which the islands have an average size of about 1 μm to about 10μm.

19. A dicing die bonding film, comprising:
a support film;
an adhesive layer on the support film; and
a pressure sensitive adhesive film on the adhesive layer, wherein:
the pressure sensitive adhesive film includes:
a polymer binder resin A;
a UV-curing urethane acrylate oligomer B1;
a UV-curing acrylate B2;
a heat curing agent C; and
a photopolymerization initiator D,
the pressure sensitive adhesive film includes about 20 to about 150 parts by weight of the UV-curing urethane acrylate oligomer B1 per 100 parts by weight of the polymer binder resin A,
the pressure sensitive adhesive film includes about 5 parts to about 50 parts by weight of the UV-curing acrylate B2, per 100 parts by weight of the polymer binder resin A, the UV-curing urethane acrylate oligomer B1 is a solid or near-solid at room temperature and have a viscosity of about 10,000 cps or more at 40° C., and
the UV-curing acrylate B2 is a solid or wax and has a melting point above about 25° C.

20. The dicing die bonding film as claimed in claim 19, wherein the UV-curing urethane acrylate oligomer B1 includes a copolymer of a terminal isocyanate urethane prepolymer and a hydroxy acrylate.

21. The dicing die bonding film as claimed in claim 20, wherein the UV-curing acrylate B2 includes one or more of trimethylolpropane tri(meth)acrylate, pentaerythritol tetraacrylate, tris(2-acryloxyethyl)isocyanulate, methoxy polyethyleneglycol 1000 methacrylate, methoxy polyethyleneglycol 1000 acrylate, behenyl acrylate, polyethyleneglycol 1000 dimethacrylate, polyethyleneglycol 1000 diacrylate, or tetramethylolmethane tetraacrylate.

22. The dicing die bonding film as claimed in claim 21, wherein the adhesive layer includes an acryl resin.

23. The dicing die bonding film as claimed in claim 19, wherein the pressure sensitive adhesive film has a sea-island structure in which the islands have an average size of about 1 μm to about 10 μm.
